(19) United States
(12) Patent Application Publication
(10) Pub. No.: US 2015/0220991 A1
(43) Pub. Date: Aug. 6, 2015

(54) EXTERNAL MESSAGING IN THE AUTOMOTIVE ENVIRONMENT

(71) Applicant: Harman International Industries, Incorporated, Stamford, CT (US)

(72) Inventors: Donald Butts, Milford, CT (US); Rajesh Khandelwal, Princeton Junction, NJ (US); Seonman Kim, Palo Alto, CA (US)

(73) Assignee: Harman International Industries, Incorporated, Stamford, CT (US)

(21) Appl. No.: 14/173,309

(22) Filed: Feb. 5, 2014

(51) Int. Cl. G06Q 30/02

(52) U.S. Cl. CPC G06Q 30/0265

(57) ABSTRACT

Systems, methods, and computer program products to perform an operation, by selecting a digital content based on an advertising context, and outputting at least a portion of the selected digital content for display on a transparent display proximate to a window of a display vehicle, whereby the digital content is viewable from a perspective external to the display vehicle.

### BACKGROUND

### Description of the Related Art

Automobile advertisements have traditionally been targeted at the driver of a vehicle, creating numerous safety concerns. Recently, printed advertisement wraps have been placed on a vehicle's exterior in order to target people outside of the car. However, these wraps are static advertisements that also present safety concerns because they can obscure the driver's view.

### SUMMARY

Embodiments disclosed herein include, but are not limited to, a system, method, and computer program product to perform an operation, by selecting a digital content based on an advertising context, outputting at least a portion of the selected digital content for display on a transparent display proximate to a window of a display vehicle, whereby the digital content is viewable from a perspective external to the display vehicle.

### BRIEF DESCRIPTION OF THE DRAWINGS

So that the manner in which the above recited aspects are attained and can be understood in detail, a more particular description of embodiments of the disclosure, briefly summarized above, may be had by reference to the appended drawings.

It is to be noted, however, that the appended drawings illustrate only typical embodiments of this disclosure and are therefore not to be considered limiting of its scope, for the disclosure may admit to other equally effective embodiments.

FIG. 1 is a schematic illustrating external messaging in the automotive environment, according to one embodiment.

FIG. 2 is a schematic illustrating external messaging in the automotive environment, according to one embodiment.

FIG. 3 illustrates a method for external messaging in the automotive environment, according to one embodiment.

FIG. 4 illustrates a method to identify a display vehicle, according to one embodiment.

FIG. 5 illustrates a method to determine advertising context, according to one embodiment.

FIG. 6 illustrates a system for external messaging in the automotive environment, according to one embodiment.

### DETAILED DESCRIPTION

Embodiments disclosed herein display digital messages on vehicles equipped with transparent displays, which are translucent from the inside out, in order to target consumers outside of the vehicle while not causing safety concerns inherent in other vehicle-based advertising forms. By displaying the digital advertisements on the transparent displays embedded in the vehicle windows and/or rear windshield, a vehicle occupant (e.g., a driver or other occupant) is able to see through the windows of the vehicle, while people outside the vehicle can see the digital advertisements on the transparent displays. The vehicle can be any type of vehicle equipped with a transparent display, such as a car, bus, taxi, or train.

The digital advertisements displayed may be targeted to a driver or passengers of other vehicles, or a group of people outside the car. Some embodiments disclosed herein select targeted advertisements based on an advertising context, which includes, but is not limited to, a location of the vehicle, a set of preferences of a consumer targeted by the advertisement, the consumer's social media profiles, and other consumer metadata.

For example, for a target user driving vehicle 1, embodiments disclosed herein may determine that vehicle 2 is in front of vehicle 1. Vehicle 2 may be identified by any feasible method, such capturing an image of the license plate of vehicle 2 to resolve identification information, or through wireless communications between vehicle 1 and vehicle 2, or wireless communications between vehicle 2 and one of a plurality of wireless transmitter devices placed at stop signs, traffic signs, and other infrastructure locations. Once vehicle 2 is identified as a “display vehicle,” embodiments disclosed herein may determine the advertising context based one or more of the locations of the vehicles, a profile of the driver of vehicle 1, the driver's preferences, and other metadata of the driver. For example, the vehicles may be at a stop sign outside of a sporting complex, and the driver of vehicle 1 may have profile metadata indicating he enjoys soccer. Therefore, embodiments disclosed herein may display a soccer advertisement on the rear windshield of vehicle 2. The advertisement may be stored locally in vehicle 2, or transmitted to vehicle 2 from a cloud-based server, another vehicle, or a wireless transmitter. Furthermore, if multiple drivers, pedestrians, or other individuals located near each other enjoy soccer, the soccer advertisement may span across multiple cars. Further still, the display vehicle may display multiple advertisements on a single transparent display, as well as one or more advertisements on different transparent displays in the display vehicle.

Although embodiments disclosed herein generally refer to displaying “advertisements,” any type of digital content may be displayed on a vehicle window. For example, “digital content” may include without limitation, advertisements, navigation information, emails, SMS messages, calendar notifications, news, blogs posts, social media posts, articles, scores of sporting events. A broad range of digital content may therefore be displayed. In addition, different mechanisms such as pull and push mechanisms may be used to deliver the digital material. Furthermore, targeted advertisements or other digital material may be pulled from one or more sources to a display vehicle targeted at another vehicle. For example, a local business may push its own advertisements to display vehicles. Targeted and non-targeted ads for the general population outside the vehicle may be pushed from the cloud or other sources. The ads may be targeted to specific individuals outside of the vehicle based on communications with an enabled device, such as a laptop, smartphone, or tablet.

Reference to a window or display configured to output images oriented for viewing from a perspective external to a vehicle indicates that the image (and the content thereof) is properly viewed from the perspective of a person outside the vehicle. For example, if the image includes text, the text is properly read by a person outside the vehicle, while appearing inverted to a person inside the vehicle.

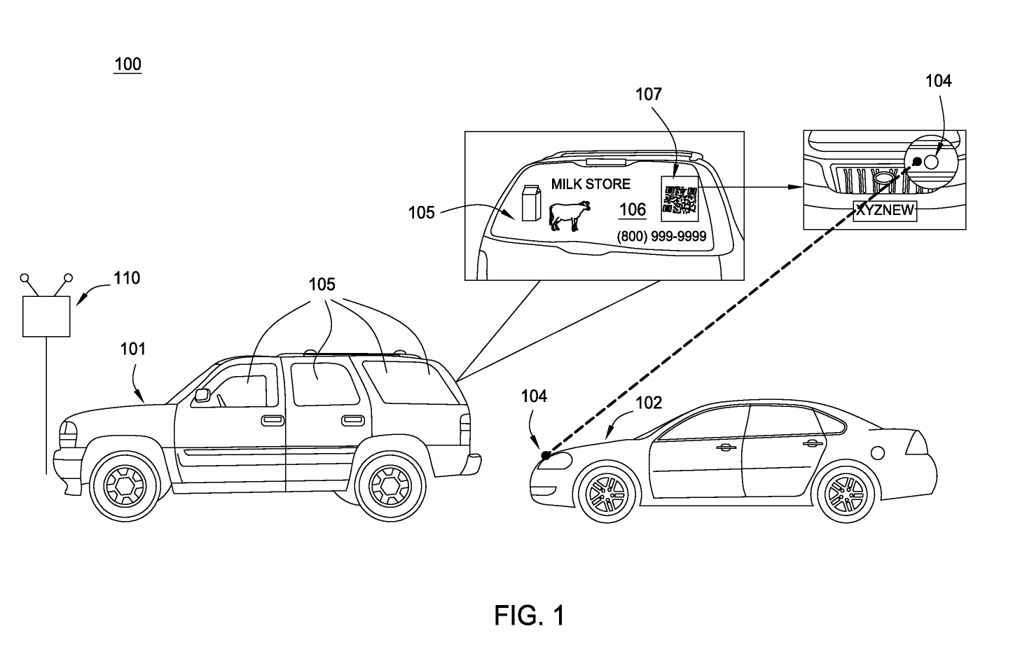

FIG. 1 is a schematic 100 illustrating external messaging in the automotive environment, according to one embodiment. Generally, the schematic illustrates a scenario where a transparent display in one vehicle is used to display an advertisement directed at people in a second vehicle, and possibly at people outside of both vehicles. As shown, a display vehicle 101 is positioned in front of a target vehicle 102. The vehicles 101, 102 may be stationary, or traveling at some speed. As shown, the windows 105 of the vehicle 101 are equipped with transparent displays, which allow digital images to be displayed on the windows 105 such that they are only visible from the outside-in, and not from the inside-out. Although not shown, the windows of vehicle 102 may also include transparent displays. Logic inside the vehicles 101, 102 may be configured to cause one or more advertisements targeted to the driver (or passengers) of the vehicle 102 to be displayed on the windows 105 of the vehicle 101 based on an advertising context.

In order to target advertisements to the occupants of the vehicle 102, embodiments disclosed herein may identify a display vehicle that may display the advertisements on its windows. In order to identify a display vehicle, embodiments disclosed herein may leverage one or more identification techniques. For example, a camera 104 on the vehicle 102 may recognize a QR identification code on the vehicle 101. As another example, the camera 104 on the vehicle 102 may capture image data of the rear license plate of the vehicle 101. The vehicle 102 may be equipped with logic to identify the character sequence and the state/country of the license plate on the vehicle 101, which may then be used to resolve identification information about the vehicle 101. In another embodiment, vehicle 102 may broadcast a wireless signal to nearby vehicles, and receive a response from vehicle 101 with identification information. In still another embodiment, a wireless transmitter 110 at a stop sign, traffic light, or any other location may initiate wireless communications with the vehicle 101 in order to retrieve its identification information. The identification information may include whether the vehicle 101 has transparent displays in its windows, its current location, and any other metadata about the vehicle or users associated with the vehicle 101 who have created profiles.

Once the logic in the vehicle 102 (or the cloud computing environment or wireless transmitter 110) identifies the vehicle 101 as a display vehicle capable of displaying advertisements, the logic may determine the advertising context in order to select advertisements targeted to vehicle 101 from a larger pool of available advertisements. Generally, the advertising context may be based on any number of factors, including metadata and user preferences in user profiles associated with the vehicle 102, a location of the vehicles 101, 102, calendar or task data in the user profiles, user social media profiles, and the like. The user profiles may include any metadata, such as user preferences, purchase history, biographical information, and the like. For example, a calendar entry in the user profiles associated with vehicle 102 may indicate that the user needs to buy milk at a grocery store, and the user frequently makes purchases at a preferred grocery store. The logic in the vehicle 101 or 102 may identify this entry and determine that at least one of the vehicles 101, 102 are within a predefined distance of the user's preferred grocery store. Based on this advertising context, the logic may select an advertisement 106 for the preferred grocery store, and cause the advertisement 106 to be displayed on the transparent display of the rear windshield 105 (or one or more other windows 105) of the vehicle 102. The advertisement 106 may be stored locally in the vehicle 101 or 102, or some nearby vehicle. If the advertisement 106 is not stored in the vehicle 101, the vehicle 101 may receive the advertisement 106 from any number of other sources, such as the vehicle 102, a cloud-based advertisement server, or one or more wireless transmitters 110 that are in range of the vehicle 101.

As shown, the advertisement 106 also includes a quick response (QR) code 107. The QR code 107 may be read by the camera 104, which may cause the vehicle 102 to perform one or more operations. For example, an onboard infotainment system of the vehicle 102 may display navigation instructions to the grocery store in the advertisement 106, provide discounts or coupons for the grocery store, or display more information about the grocery store. As another example, a computing device such as a smart phone, tablet, or laptop may display the navigation instructions or additional information. In one embodiment, someone in the vehicle 102 may be prompted by the infotainment system or the computing device to accept the additional information or navigation instructions before displaying the additional information or navigation instructions. The QR code 107 may also be used to identify one or more user profiles of the vehicle 102 in order to provide reward incentives to the user. For example, the user of the vehicle 102 may receive rewards for displaying the advertisement 106, and for each time another vehicle (or other device, such as a smartphone, tablet, glasses, or the like) scans the QR code 107. Although FIG. 1 depicts an embodiment where the QR code 107 is used to trigger the operations in the vehicle 102, other transmissions technologies, such as radio communication via a cellular tower or Bluetooth® may be used.

In at least one embodiment, the vehicle 101 may display advertisements while the vehicles 101, 102 are in motion. In such an embodiment, the rear view mirrors of the vehicle 101 may have sensors used to detect whether the driver of the vehicle 101 is looking at the rear view mirror while an advertisement (or other information) is displayed on the rear windshield. If the driver is looking at the rear view mirror, the advertisement may be temporarily removed (completely or partially) from display until the driver moves his focus away from the rear view mirror. In some instances, this may be necessary if the transparent display of the rear windshield is not completely transparent, and potentially obstructing the driver's view out of the rear windshield.

In other embodiments, vehicles such as the vehicle 101 do not display advertisements until the vehicles are stopped, or travelling at a speed that is lower than a predefined speed threshold, such as 5 miles per hour. In some such embodiments, the wireless transmitter 110 may be mounted to a stop sign, traffic light, or other fixture in order to provide a signal triggering the selection and display of one or more advertisements.

The logic in the vehicles may display any number of advertisements to the vehicle 102, or by the vehicle 101. In addition, messages other than advertisements may be displayed. For example, contact information, emails, calendar events, and the like may be displayed in lieu of, or in addition to, an advertisement. Additionally, if a user dines at a restaurant, the user may be prompted to rate the restaurant on one or more platforms. A display period for each advertisement may have a predefined duration, with a new advertisement selected and displayed based on an updated context when the predefined duration expires. If an advertisement is not displayed for a minimum display duration on a display vehicle, such as the vehicle 101, embodiments disclosed herein may select a different nearby vehicle (not pictured) to display the advertisement in order to ensure that the advertisement is displayed for the minimum duration. Furthermore, the vehicle 102, upon reading the advertisement 106, may display the advertisement 106 on one of its own windows. In another embodiment, the vehicles 101, 102 may be parked or stopped next to each other, with a window of each vehicle being used to display a respective portion of a common advertisement.

The messaging displayed on the vehicles may also include a “game” that encourages participation by a number of vehicles in the form of an interactive advertisement. For example, at the display vehicle 101 may output an interactive advertisement that tells people to vote for their favorite football team. Users may then vote for their favorite team using their smartphones or other devices via wireless data connections. The votes may be received and tallied by the display vehicle 101, or a cloud computing system. The display vehicle 101 or the cloud computing system may then modify the interactive advertisement to reflect the team that received the most votes from the users. Vehicle owners/drivers who allow the system to be displayed on their vehicles may be rewarded each time a user votes/clicks on the advertisement displayed on the vehicle.

When displayed, ads served to users outside the display vehicle 101 may “follow” the user around the display vehicle 101, causing the advertisements to be displayed on a window nearest to the user. For example, if the user walks from the passenger side to the rear of the display vehicle 101, the ads may “follow” the user from the front passenger side window to the rear passenger side window to the rear windshield, based on GPS coordinates or signal detection from Bluetooth, radio-frequency identification (RFID), and near field communication (NFC) enabled devices. For example, if a person's car keys have an RFID tag, the display vehicle 101 may detect the person's location based on detecting the RFID tag of the keys (even if they are not for the display vehicle), and output an advertisement on a window corresponding to the person's location.

In addition, vehicle-based cameras (not pictured) may take photographs of passers by near the display vehicle 101, which may be analyzed to determine different information about the passers by. For example, by analyzing an image of a person, logic in the display vehicle 101 may determine that the person is a middle-aged male wearing a shirt of a particular football team. In response, an ad for football or the team may be displayed on a window 105 of the display vehicle 101 nearest to the person.

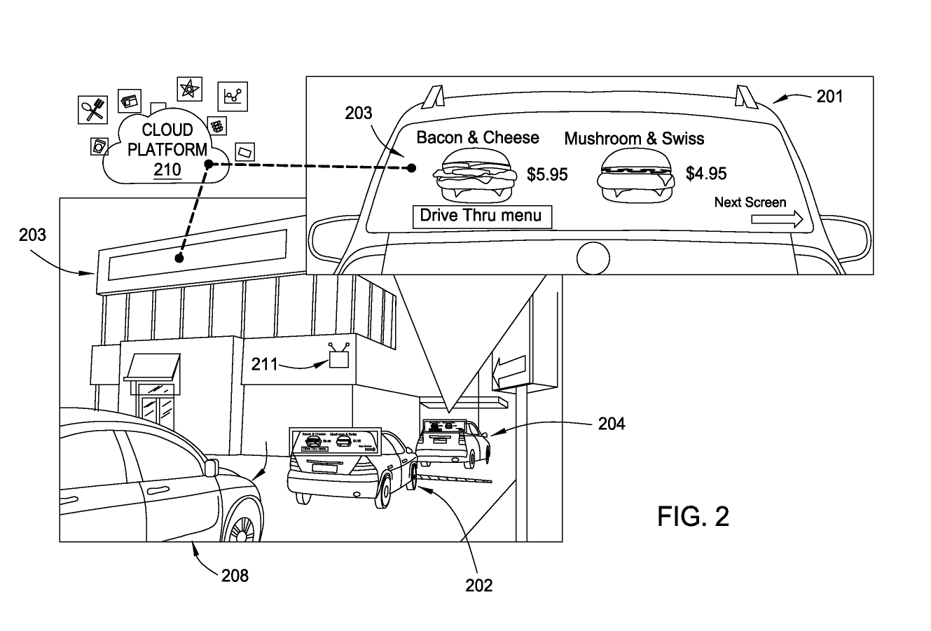

FIG. 2 is a schematic 200 illustrating external messaging in the automotive environment, according to one embodiment. As shown, vehicles 201, 202 are in a drive-thru lane of a restaurant 205. Logic in the vehicles 201, 202 has displayed an advertisement 204, which is a menu for the restaurant 205 in transparent displays of the rear windshields 203 of each vehicle. The advertisement 204 may be transmitted to the vehicles 201, 202 through a cloud platform 210 via a wireless transmitter 211. Alternatively, the transmitter 211 may be coupled to a storage device including local store advertisements which the transmitter 211 may serve to the cars without the need for the cloud platform 210. The wireless transmitter 211 may detect the presence of the vehicles 201, 202 and cause the vehicles 201, 202 to display the advertisement 204 on their respective windshields 203. The advertisement may be a menu, which may include different offers, limited time specials, or any other promotional material.

In some embodiments, an advertising context is computed in order to select an appropriate advertisement 204 for each vehicle 201, 202. For example, knowledge that the cars are outside of the restaurant 205 may factor into the type of advertisement displayed. The preferences of users behind the vehicles 201, 202 may also be considered as part of the advertising context. For example, if the profile data of the driver of vehicle 202 indicates that the driver enjoys chicken sandwiches, the rear windshield 204 of vehicle 201 may display a special offer for a discounted chicken sandwich, or display a portion of the restaurant's menu related to chicken sandwiches. If a social media profile of the driver or a passenger of vehicle 208 indicates she enjoys cheeseburgers, the vehicle 202 may display a cheeseburger special in order to encourage her to make a purchase. As another example, the vehicles 201, 202 may target the general public walking outside the restaurant 205. In such a context, the vehicles 201, 202 may display general advertisements, menus, or promotions for the restaurant 205. Generally, any digital material, including commercials, still images, videos, and other media may be displayed.

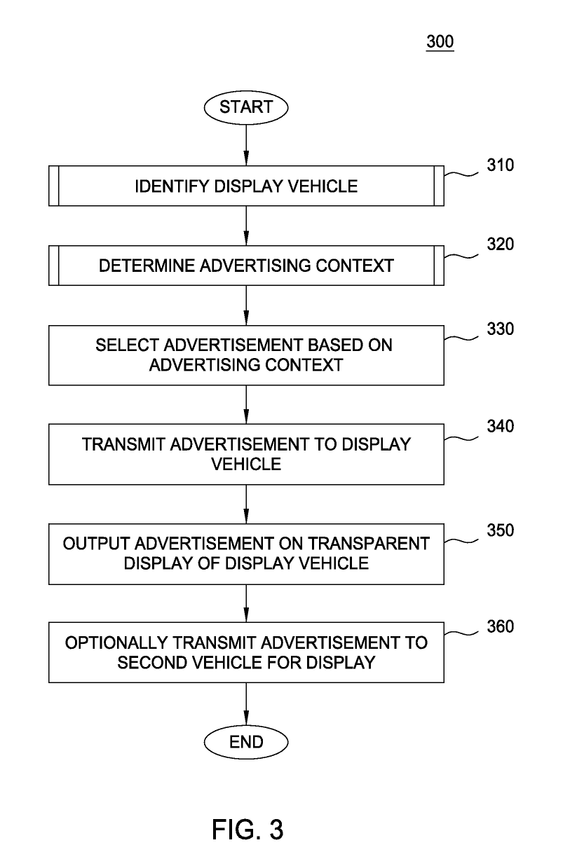

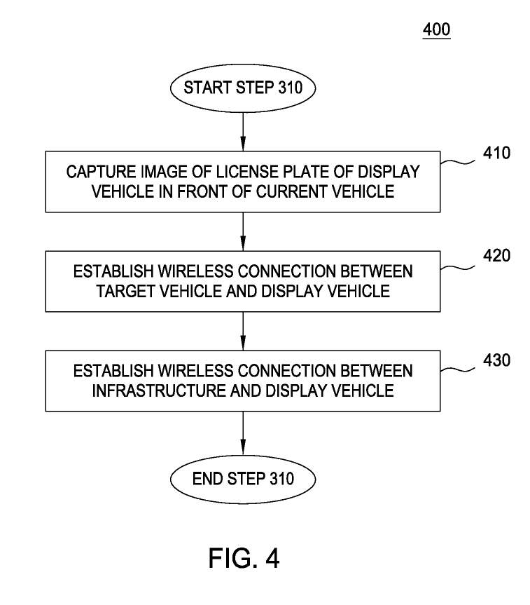

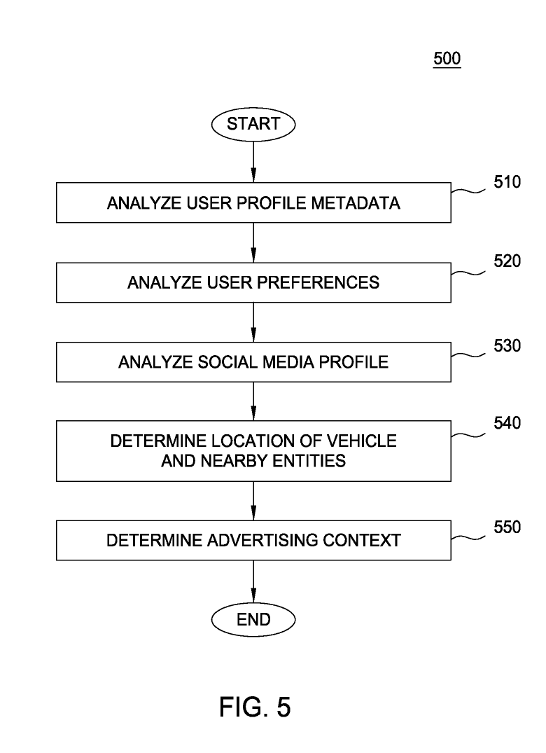

FIG. 3 illustrates a method 300 for external messaging in the automotive environment, according to one embodiment. Generally, the steps of the method 300 provide targeted advertising by selecting a display vehicle, computing an advertising context, selecting an advertisement based on the advertising context, and displaying the advertisement in a transparent display in a window of the display vehicle. In addition to, or in lieu of an advertisement, any type of digital content may be displayed on the window of the display vehicle. The steps of the method 300 may be orchestrated by a distributed application executing in at least one of one or more vehicles, a cloud computing environment, and wireless transmitters making up a networking infrastructure. At step 310, described in greater detail with reference to FIG. 4, the distributed application identifies one or more display vehicles, which are used to display an advertisement on one or more transparent displays in their windows. At step 320, described in greater detail with reference to FIG. 5, the application determines an advertising context. In determining the advertising context, the application generally considers a location of a target vehicle (or the display vehicle), establishments in proximity to the location, registered users' social media profiles, user metadata and preferences stored in a general profile, and any other relevant and available information, such as vehicle information, the date, time of day, season, and the like.

At step 330, the application selects an advertisement (or other digital content) based on the advertising context. For example, if a target vehicle is low on gas, and the target vehicle is located at a traffic light near two or more competing gas stations, wireless transmitters at the traffic lights may send advertisements for one or more of the gas stations to a display vehicle in front of the target vehicle. The advertisements, displayed on the display vehicle, may include special discounts in order to cause the driver of the target vehicle to patronize one gas station over the other. At step 340, the application transmits the selected advertisement to the display vehicle (if the display vehicle does not already have a copy of the advertisement). Generally, any source may transmit the advertisement, such as an advertisement server in a cloud computing environment, a wireless transmitter, or other nearby vehicles. At step 350, the display vehicle outputs the advertisement on a transparent display of the display vehicle. At step 360, the application may optionally transmit the advertisement to a second display vehicle for display. For example, if several cars are parked in a parking lot, each of their rear windshields may be used to display a respective portion of a larger advertisement.

In other embodiments, the distributed application may display other information on the target vehicle, such as calendar information, events, navigation instructions, SMS messages, to do list entries, and the like. The other information may be in addition to an advertisement, or may be displayed without an advertisement. Generally, the distributed application may display any type of information on the display vehicle, according to user preferences. For example, two passengers in two separate vehicles can play a multi-user game displayed on the side window of their respective vehicles. The side windows may further be touch-sensitive, allowing for user input that controls the game. Gamification may be implemented to engage different users.

FIG. 4 illustrates a method 400 corresponding to step 310 to identify a display vehicle, according to one embodiment. Generally, the distributed application may execute the steps of the method 400 leverage different techniques in order to identify a vehicle with a transparent display that may be used to display targeted advertisements or other information to a driver or passenger of a target vehicle, or individuals outside of the display vehicle. Users may opt in to the service in order to allow their vehicles display advertisements to other vehicles. In one embodiment, users may receive points, subsidies, coupons, or other rewards in return for their participation. Users may receive points for how many people act upon the ads displayed on their vehicles, and may receive more points for displaying specific types or classes of advertisements on their vehicles. At step 410, the distributed application executing on a target vehicle captures image data of a license plate of a display vehicle in front of the target vehicle. The distributed application may use the image data to extract the license plate information, which the application may then use to resolve identification information of the display vehicle. In one embodiment, the distributed application executing on the target vehicle extracts the license plate information. In another embodiment, the image data is sent to a cloud-based server, where the distributed application may extract the license plate information. In either case, the extracted license plate data is used to resolve identification information related to the display vehicle, such as its GPS location, and the like. The identification information may be local to the target vehicle, or in the cloud.

At step 420, the distributed application of the target vehicle may establish a wireless connection with a display vehicle. Once the wireless connection is established, the distributed application of the display vehicle may transmit identification information to the target vehicle (or to the cloud-based server). At step 430, a wireless infrastructure component (such as a wireless transceiver) executing the distributed application may establish a wireless connection with the display vehicle. The display vehicle may then send identification information to the wireless infrastructure component. The distributed application of the wireless infrastructure component may then use the identification information to serve advertisements, or may transmit the identification information to the cloud-computing environment.

FIG. 5 illustrates a method 500 corresponding to step 320 to determine advertising context, according to one embodiment. Generally, the distributed application may execute steps of the method 500 leverage different types of data in order to determine an advertising context that is used to select and serve targeted advertisements. Any number of data types, and any type of data may be used to compute the advertising context, such as GPS, navigation information, SMS, emails, to do lists, and the like. User data may be analyzed for one or more individuals in the target vehicle, or generic individuals outside of the vehicles. At step 510, the distributed application may analyze user profile metadata. The user profile metadata may include biographic information, purchase histories, calendar information, task/to do list information, and the like. For example, the metadata may indicate that the user is a male in his 50s who drives an upscale sedan and frequently purchases goods from a custom widget maker. Based on this profile information, the advertising context may indicate that a widget advertisement is appropriate for this user. At step 520, the distributed application analyzes user preference data. The user preference data may include explicit preferences defined by the user, or preferences inferred by the distributed application. For example, the user may express a preference for the custom widgets, while the distributed application may determine that a specific widget maker is his preferred maker, based on his previous purchase history. The preference data may encompass any type and number of preferences, such as vehicle preferences (such as radio presets), hobbies, interests, sports, movies, books, and the like.

At step 530, the distributed application may analyze a social media profile of users in the target vehicle to identify relevant information. The relevant information may include additional preferences, dislikes, posts, associations, friendships, or other data that the distributed application may analyze to enrich the advertising context with social media profile data. For example, if a user's social media profile has repeated posts indicating a preference for a specific movie, the distributed application may include the movie, its genre, and other related attributes as part of the advertising context. Continuing with the widget example, the distributed application may find many widget-related posts and other indications that the widgets are one of the user's main hobbies. At step 540, the distributed application may determine the location of the target (and/or display) vehicle using the GPS units in the vehicles. The distributed application may use the vehicle locations in order to further refine the advertising context. For example, if the vehicles are located within a predefined distance of an advertising entity, such as a business, restaurant, or other retailer, the distributed application may include the location and proximity in the advertising context, which may ultimately result in the selection of an advertisement for one of these local entities. Continuing with the widget example, a local widget retailer may be within a predefined distance of the vehicles.

At step 550, the distributed application determines the overall advertising context based on all gathered information. For example, the distributed application may leverage the location data, profile metadata, user preferences, and the social media data in order to determine the advertising context. The advertising context may generally include a set of attributes, or parameters, that may then be matched against metadata of one or more available advertisements. Continuing with the widget example, the advertising context may specify to provide an advertisement related to custom widgets for a retailer within a predefined distance of the current location of the vehicles. Generally, the advertising context may take any format sufficient to specify the one or more attributes or parameters of the advertising context.

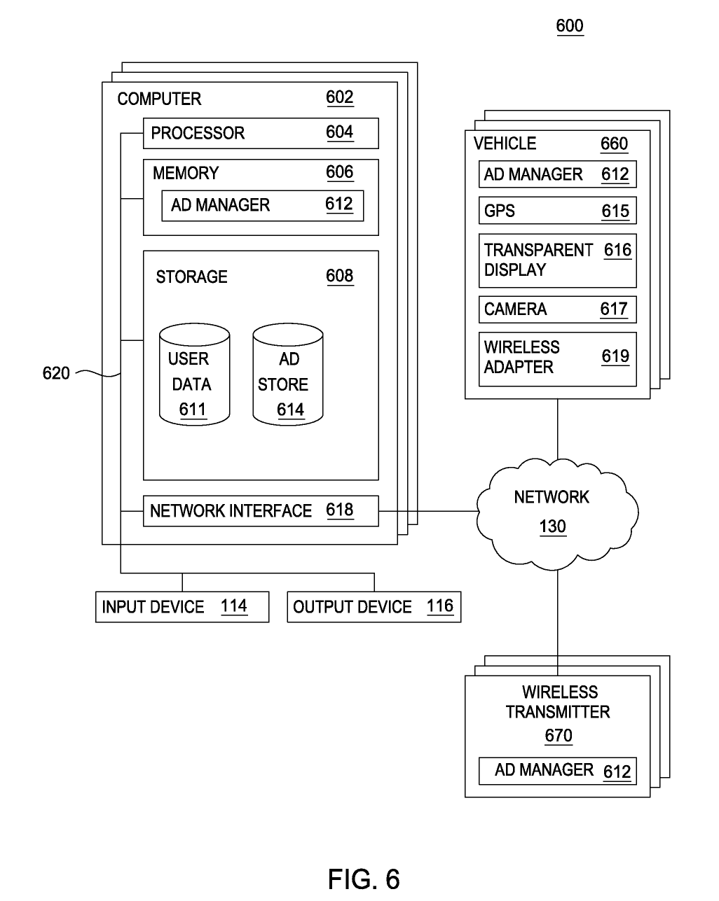

FIG. 6 illustrates a system 600 for external messaging in the automotive environment, according to one embodiment. The networked system 600 includes a computer 602. The computer 602 may also be connected to other devices via a network 630. In general, the network 630 may be a telecommunications network and/or a wide area network (WAN). In a particular embodiment, the network 630 is the Internet. In one embodiment, the computer 602 is one of a plurality of servers in a cloud computing environment configured to serve targeted advertisements to one or more vehicles 660 or wireless transmitters 670 via wireless connections.

The computer 602 generally includes a processor 604 connected via a bus 620 to a memory 606, a network interface device 618, a storage 608, an input device 622, and an output device 624. The computer 602 is generally under the control of an operating system (not shown). Generally, any operating system supporting the functions disclosed herein may be used. The processor 604 is included to be representative of a single CPU, multiple CPUs, a single CPU having multiple processing cores, and the like. The network interface device 618 may be any type of network communications device allowing the computer 602 to communicate with other devices, such as the vehicles 660 (through the wireless adapter 619) and the transmitters 670 via the network 630.

The storage 608 may be a persistent storage device. Although the storage 608 is shown as a single unit, the storage 608 may be a combination of fixed and/or removable storage devices, such as fixed disc drives, solid state drives, SAN storage, NAS storage, removable memory cards or optical storage. The memory 606 and the storage 608 may be part of one virtual address space spanning multiple primary and secondary storage devices.

The input device 622 may be any device for providing input to the computer 602. For example, a keyboard and/or a mouse may be used. The output device 624 may be any device for providing output to a user of the computer 602. For example, the output device 624 may be any display screen and/or set of speakers. Although shown separately from the input device 622, the output device 624 and input device 622 may be combined. For example, a display screen with an integrated touch-screen may be used.

As shown, the memory 606 contains the ad manager 612, which is an application generally configured to serve targeted advertisements (and other digital content) on one or more transparent displays 616 of a vehicle 660. The ad manager 612 may execute on the cloud computer 602, a computer of the vehicle 660, and in a wireless transmitter 670, with each instance orchestrating the functionality of the ad manager 612. In some embodiments, the vehicles 660 execute the ad manager 612 as part of an information delivery system (also referred to as an in-vehicle infotainment (IVI) system). The ad manager 612 may be configured to identify a vehicle 660 as a display vehicle, which will display one or more targeted advertisements. When executing on a vehicle 660, the ad manager 612 may use pixel data obtained from the camera 617 in order to scan a license plate of a target vehicle 660. Once the license plate data is obtained, the ad manager 612 may determine whether the vehicle 660 associated with the license plate has transparent displays 616 available to display targeted advertisements. Once the ad manager 612 identifies a participant vehicle, via its license plate, it may resolve parameters associated with the vehicle, such as location data from the global positioning system (GPS) 615. In other embodiments, the ad manager 612 may identify a display vehicle by initiating wireless communications between wireless adapters 619 of two or more vehicles 660, or between the cloud computer 602 and a vehicle 660, or a wireless transmitter 670 and the wireless adapter 619 vehicle 660. The current location of a target vehicle 660 may be used to narrow the range of vehicles 660 targeted as potential display vehicles.

In addition, the ad manager 612 may determine an advertising context that is used to select an appropriate advertisement from the ad store 614 for display on the display vehicle 660. The ad manager 612 may use the location of the target (or display) vehicle 660 and draw from the user data 611, as well as other data sources in order to determine the advertising context. For example, if the target vehicle 660 is near an amusement park, and the user data 611 specifies that a user associated with the target vehicle enjoys amusement parks, the ad manager 612 may select an advertisement for the amusement park from the ad store 614, send the advertisement to the display vehicle, and display the advertisement on the transparent display 616 of the vehicle 660. If the vehicle 660 is parked outside of the amusement park, the ad manager 612 may cause advertisements targeted at the amusement park attendees using generalized preference data in user data 611 that is tailored to individuals who attend amusement parks. In some embodiments, the transparent display 616 may also simultaneously display more than one targeted advertisement.

The transparent display 616 may be a part of a window of the vehicle 660, and is generally configured to display images and/or video such that the displayed information is only viewable from the outside, and not the inside, of the vehicle 660. In one embodiment, one or more vehicles 660 may use pico-projection and special coated film on the windows that are used to display images or video on the rear and side windows of the vehicle. The transparent display 616 may also be an OLED display capable of displaying one or more messages described herein. In addition, the ad manager 612 may be configured to display user-specific data on the windows of a target vehicle 660. For example, a user may see a meeting reminder displayed on the rear windshield of the vehicle 660 in front of him. The wireless adapter 619 of the vehicle 619 may be any type of adapter configured to perform wireless communications according to any standard, such as 802.11 standards, cellular data standards, and the like.

The wireless transmitters 670 may be positioned at different locations along roads, highways, and buildings. The wireless transmitters 670 are configured to execute an instance of the ad manager 612, and perform wireless communications with the vehicles 660 and the cloud computers 602. Although not shown, the wireless transmitters 670 and vehicles 660 may each include local copies of the user data 611 and ad store 614, such that they need not have a connection to the cloud computers 602 in order to serve targeted advertisements.

As shown, storage 608 contains the user data 611, which generally includes any type of data related to one or more users. For example, the user data 611 may include user preferences, metadata, social media profile data, calendar data, to-do lists, SMS messages, email data, or any other type of data associated with a user. The storage 608 also includes the ad store 614, which is configured to store one or more advertisements. The advertisements may be still images, video, and may include audio. Generally, any type of digital advertisement or other digital content may be stored in the ad store 614. The ad store 614 may also include metadata for each advertisement. For example, a display count, feedback ratings, and other metadata of the advertisements may be stored in the ad store 614.

Advantageously, embodiments disclosed herein provide safe, targeted messages using transparent displays in the windows of vehicles. The use of transparent displays means that the driver of the vehicle cannot see the message (such as an advertisement) on the windows of his vehicle, as the messages are only viewable from the outside-in, not inside-out. Generally, once embodiments disclosed herein identify a target vehicle, the target vehicle may display any type of message, such as an advertisement or other notification. The target vehicle may be identified by scanning license plates or wireless communications protocols. Embodiments disclosed herein may compute an advertising context in order to select an appropriate advertisement that is targeted to one or more viewers.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the ad manager 612 could execute on a computing system in the cloud and serve targeted advertisements on transparent displays of vehicles. In such a case, the ad manager 612 could serve targeted advertisements and store user metadata and the advertisements at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
selecting a digital content based on an advertising context comprising a user profile; and
outputting at least a portion of the selected digital content for display on a transparent display proximate to a window of a display vehicle, whereby the digital content is viewable from a perspective external to the display vehicle.

2. The method of claim 1, wherein the advertising context comprises a location of a target vehicle, wherein the selected digital content is for an advertising entity that is located within a predefined distance of the location of the target vehicle.

3. The method of claim 1, further comprising identifying the display vehicle, wherein identifying the display vehicle comprises at least one of: (i) reading a license plate of the display vehicle, (ii) reading a QR code on the display vehicle, and (iii) performing wireless communications with the display vehicle.

4. The method of claim 1, wherein the window comprises a rear windshield of the display vehicle, wherein the selected digital content is not viewable from a perspective interior to the display vehicle.

5. The method of claim 1, wherein the user profile comprises: (i) one or more user preferences, (ii) one or more user calendar entries, and (iii) user metadata.

6. The method of claim 1, wherein the outputted digital content includes a Quick Response (QR) code associated with at least one of: (i) an advertising entity associated with the outputted digital content, (ii) the display vehicle, wherein the method further comprises:
displaying, in a target vehicle reading the QR code, navigation instructions to the advertising entity.

7. The method of claim 6, further comprising:
upon determining that the QR code has been read by at least one of the target vehicle and another device, updating a weight of the outputted digital content.

8. The method of claim 1, further comprising:
receiving, by the display vehicle, the selected digital content, wherein the selected digital content is received by the display vehicle from at least one of: (i) a vehicle in proximity to the display vehicle, (ii) a cloud-based advertisement server, and (iii) a transmitter device configured to store digital content for one or more advertising entities.

9. The method of claim 1, wherein the display vehicle comprises two or more adjacent vehicles, wherein a window of each of the two or more adjacent vehicles is used to display a respective portion of the selected digital content.

10. A computer program product, comprising:
a computer-readable storage medium having computer-readable program code embodied therewith, the computer-readable program code comprising:
computer-readable program code configured to select a digital content based on an advertising context; and
computer-readable program code configured to output at least a portion of the selected digital content for display on a transparent display proximate to a window of a display vehicle, whereby the digital content is viewable from a perspective external to the display vehicle.

11. The computer program product of claim 10, wherein the advertising context comprises a location of a target vehicle, wherein the selected digital content is for an advertising entity that is located within a predefined distance of the target vehicle.

12. The computer program product of claim 10, further comprising identifying the display vehicle, wherein identifying the display vehicle comprises at least one of: (i) reading a license plate of the display vehicle, (ii) reading a QR code on the display vehicle, and (iii) performing wireless communications with the display vehicle.

13. The computer program product of claim 10, wherein the window comprises a rear windshield of the display vehicle, wherein the selected digital content is not viewable from a perspective interior to the display vehicle.

14. The computer program product of claim 10, wherein the advertising context further comprises a user profile, wherein the user profile comprises: (i) one or more user preferences, (ii) one or more user calendar entries, and (iii) user metadata.

15. The computer program product of claim 10, further comprising:
computer-readable program code configured to detect a position of a person external to the vehicle; and
computer-readable program code configured to output the at least the portion of the selected digital content on a transparent display proximate to a window nearest to the position of the person.

16. The computer program product of claim 10, wherein the digital content comprises an interactive poll, wherein the computer-readable program code further comprises:
computer-readable program code configured to receive input from one or more users; and
computer-readable program code configured to output, on the transparent display, an interactive poll result based on the received input.

17. The computer program product of claim 10, wherein the computer-readable program code further comprises:
computer-readable program code configured receive, by the display vehicle, the selected digital content, wherein the selected digital content is received the display vehicle from at least one of: (i) a vehicle in proximity to the display vehicle, (ii) a cloud-based advertisement server, and (iii) a transmitter device configured to store digital content for one or more advertising entities.

18. The computer program product of claim 10, wherein the display vehicle comprises two or more adjacent vehicles, wherein a window of each of the two or more adjacent vehicles is used to display a respective portion of the selected digital content.

19. A system, comprising:
a transparent display proximate to a window of at least one display vehicle and configured to display one or more images oriented for viewing from a perspective external to a display vehicle; and
one or more computer processors configured to:
select a digital content based on an advertising context; and
output at least a portion of the selected digital content for display on the transparent display of the display vehicle.

20. The system of claim 19, wherein the window comprises a rear windshield of the display vehicle, wherein the advertising context comprises at least one of a user profile and a location of a target vehicle, wherein the selected digital content is for an advertising entity that is located within a predefined distance of the target vehicle.
